(19) United States
(12) Patent Application Publication
(10) Pub. No.: US 2005/0031441 A1
(43) Pub. Date: Feb. 10, 2005

(54) Cargo lift for a vehicle

(75) Inventor: Ming-Chuan Cheng, Taichung (TW)

Correspondence Address: VENABLE, BAETJER, HOWARD AND CIVILETTI, LLP, P.O. BOX 34385, WASHINGTON, DC, 20043-9998, US

(73) Assignee: Merits Health Products Co., Ltd., Taichung (TW)

(21) Appl. No.: 10/634,865

(22) Filed: Aug. 6, 2003

(51) Int. Cl. B65G 63/00

(52) U.S. Cl. 414/540

(57) ABSTRACT

A cargo lift for a vehicle has a motor, an upper stanchion, a lower stanchion, a platform, a platform bracket, a roller bracket, a mounting bracket, a wing and a platform storage device. The motor is connected to the upper stanchion, and the lower stanchion is mounted inside the upper stanchion. The wing is formed on the upper stanchion, and the mounting bracket is pivotally attached to the wing. The platform bracket is pivotally mounted on the lower stanchion, and the platform is attached to the platform bracket. The platform storage device mounted on the wing has an actuating arm and a spring-loaded holder. The spring-loaded holder has a compressed spring mounted inside a cylinder. When the cargo lift is assembled, the compressed spring mounted inside the cylinder prevents the compressed spring from releasing and injuring anyone. Furthermore, the cargo lift has a beautiful external appearance.

### BACKGROUND OF THE INVENTION

1. Field of the Invention

The present invention relates to a cargo lift, and more particularly to a cargo lift for a vehicle.

2. Description of Related Art

With reference to FIGS. 7 and 8, a conventional cargo lift (40) for a vehicle (60) has a motor (41), an upper stanchion (42), a lower stanchion (43), a platform (44), two platform brackets (45), a roller bracket (not numbered), a mounting bracket (47), a wing (48) and a platform storage device (not numbered).

The upper stanchion (42) is hollow and has a proximal end (not numbered), a distal end (not numbered), two front edges (not numbered), a front wall (not numbered) and two sidewalls (not numbered). One of the sidewalls has an actuating arm stop (not numbered). The actuating arm stops are formed respectively near the front edges.

The lower stanchion (43) is transverse T-shaped and has a proximal end (not numbered), a distal end (not numbered), two front edges (not numbered), a front wall (not numbered), two sidewalls (not numbered), a large roller (451), a transverse portion (not numbered) and two pivot arms (not numbered). The proximal end of the lower stanchion (43) is slidably mounted inside the distal end of the upper stanchion (42). The motor (41) is attached to the proximal end of the upper stanchion (42) and has a telescoping piston (not numbered). The large roller (451) is attached to the front wall of the distal end of the lower stanchion (43) and faces to the vehicle (60). The transverse portion is securely mounted on the distal end of the lower stanchion (43) with two free ends. Each pivot arm is respectively mounted on one of the free ends of the transverse portion.

The telescoping piston has a proximal end (not numbered) and a distal end (not number) and is moveably mounted in the upper stanchion (42). The proximal end of the telescoping piston is connected to the motor (41) and the distal end is connected to the lower stanchion (43). The motor (41) selectively extends or retracts the telescoping piston that extends or retracts the lower stanchion (43) in the upper stanchion (42).

Each platform bracket (45) is respectively mounted on the platform (44) and has an outer sidewall (not numbered). The pivot arms of the lower stanchion are attached to the outer sidewalls of the platform bracket (45), are bent away from the vehicle (60) and toward the platform and respectively have free ends (not numbered).

The roller bracket (not numbered) is securely mounted on the platform (44) and has an upper transverse arm (not numbered) and a small roller (452). The roller bracket has an upper end (not numbered). The upper transverse arm has a rear end (not numbered) and a front end (not numbered), and the rear ends are securely attached respectively to the upper end of the roller bracket. The small roller (452) is rotatably attached to the front ends of the upper transverse arm.

The wing (48) is mounted on one of the front edges of the front wall at the distal end of the upper stanchion (42) and extends toward the vehicle (60).

The mounting bracket (47) is pivotally connected to the wing (48) and has a longitudinal arm (not numbered), a transverse arm (not numbered) and an inclined corner (471). The transverse arm is attached to the vehicle (60), and the longitudinal arm is attached to the wing (48).

The platform storage device selectively raises the platform (44) to a stored position parallel to the upper stanchion (42) and has an actuating arm (49) and a spring (50). The actuating arm (49) is T-shaped, has a transverse arm (not numbered) and a longitudinal leg (not numbered) and is pivotally mounted on the wing (48). The transverse arm has a top edge (not numbered), a front end (not numbered) and a rear end (not numbered) and is integrally formed with a longitudinal leg. The spring (50) is connected between the front ends of the transverse arms and the wing (48). With the spring (50) attached to the front end of the transverse arm of the actuating arm (49), the top edge at the rear end of the transverse arm of the actuating arm (49) abut the actuating arm stop on the upper stanchion (42). The longitudinal leg has a distal end (not numbered) with enlarged feet (not numbered).

When the lower stanchion (43) is retracted into the upper stanchion (42), the large roller (451) first abuts and rolls on the inclined corner (471) of the mounting bracket (47). As the lower stanchion (43) continues to be retracted into the upper stanchion (42), the large roller (451) rolls along the longitudinal arm of the mounting bracket (47), and the small roller (452) abuts the large feet on the distal end of the longitudinal leg of the actuating arm (49).

When articles (not shown) with an additional weight are loaded on the platform (44), the weight of the articles on the platform (44) hold the platform (44) in an extended position. The small roller (452) overcomes the spring (50), pivot the actuating arm (49) and moves up along the front side of the longitudinal leg of the actuating arm (49).

When no articles are on the platform (44), the platform (44) cannot overcome the spring (50), small roller (452) is pressed down by the feet on the longitudinal leg of the actuating arm (49) as the lower stanchion (43) is retracted into the upper stanchion (42). As the small roller (452) is pressed down, the platform bracket (45) raise toward the upper stanchion (42), and the platform (44) moves to a stored position parallel to the upper stanchion (42).

The conventional cargo lift (40) for a vehicle (60) has the following disadvantages:

1. The spring (50) is directly connected to the wing (48). When assembling the cargo lift (40), the spring (50) easily slips off and injures assembly personnel.

2. The spring (50) directly attached to the wing (48) is unsightly and exposed and can pinch a person working around the cargo lift (40).

To overcome the shortcomings, the present invention provides a cargo lift for a vehicle to mitigate or obviate the aforementioned problem.

### SUMMARY OF THE INVENTION

The primary objective of the present invention is to provide a cargo lift for a vehicle.

The cargo lift in accordance with the present invention has a motor, an upper stanchion, a lower stanchion, a mounting bracket, a wing, a platform storage device, two platform brackets, a roller bracket and a platform. The motor is connected to the upper stanchion, and the lower stanchion is slidably mounted inside the upper stanchion. The wing is formed on the upper stanchion, and the mounting bracket is pivotally mounted on the wing. The platform brackets are pivotally attached to the lower stanchion, and the platform is mounted on the platform brackets. The platform storage device is mounted on the wing has an actuating arm, a retaining spring and a spring-loaded holder. The spring-loaded holder has a cylinder, a compressed spring, a second piston and a piston nut. The cylinder is hollow and has an open end and a partially closed end. The second piston has a proximal end, a distal end, a head and a shaft and is slidably mounted inside the cylinder. The head protrudes from the open end of the cylinder, and the shaft protrudes from the partially closed end of the cylinder. The compressed spring is mounted around the shaft between the head and the partially closed end of the cylinder, and the second piston nut is screwed on the shaft outside the cylinder to hold the piston in the cylinder.

When the cargo lift is assembled, the compressed spring is mounted inside the cylinder and keeps the compressed spring from releasing and injuring people. Furthermore, the external configuration of the cargo lift is more attractive.

Other objectives, advantages and novel features of the invention will become more apparent from the following detailed description when taken in conjunction with the accompanying drawings.

### BRIEF DESCRIPTION OF THE DRAWINGS

FIG. 1 is an enlarged exploded perspective view of a platform storage device for a cargo lift for a vehicle in accordance with the present invention;

FIG. 2 is a side plan view of the cargo lift for a vehicle in accordance with the present invention;

FIG. 3 is a side plan view of the cargo lift for a vehicle in FIG. 1 when the small roller abuts the actuating arm;

FIG. 4 is a side plan view of the cargo lift for a vehicle in FIG. 1 when the large roller abuts the actuating arm;

FIG. 5 is an operational plan view of the cargo lift for a vehicle in FIG. 1 when the platform is folding;

FIG. 6 is a side plan view of the cargo lift for a vehicle in FIG. 1 when the platform is folded; and

FIG. 7 is a side plan view of a conventional cargo lift for a vehicle in accordance with the prior art;

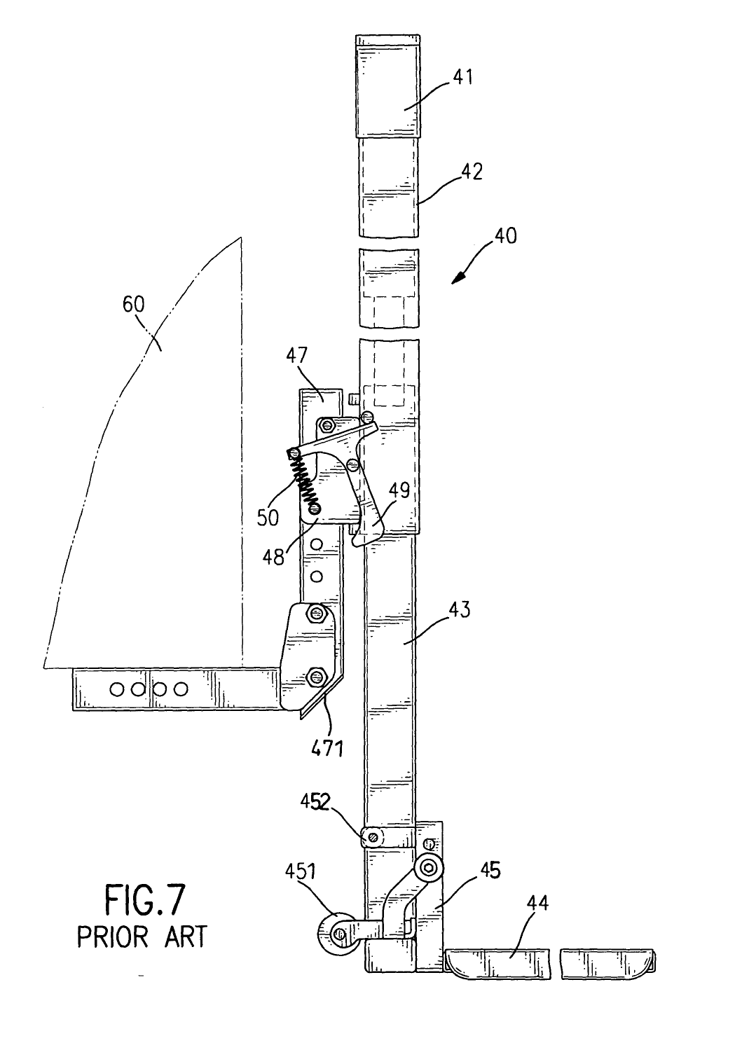

FIG. 8 is a partial exploded view of the conventional cargo lift for a vehicle in FIG. 7.

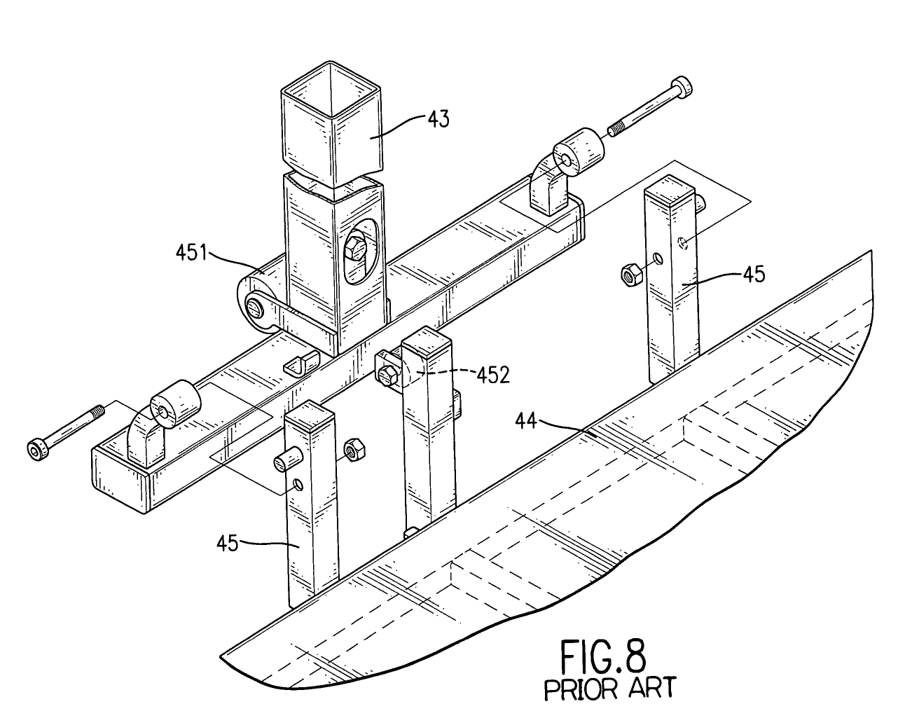

### DETAILED DESCRIPTION OF THE PREFERRED EMBODIMENT

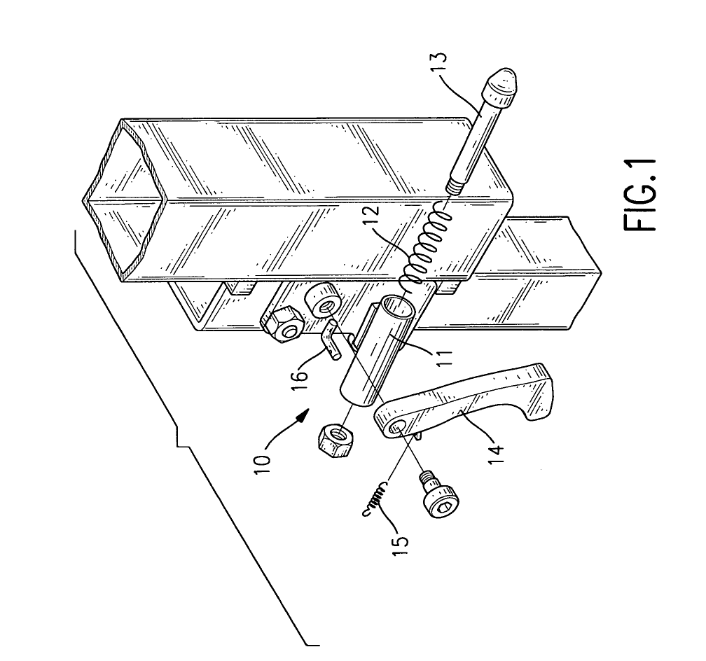

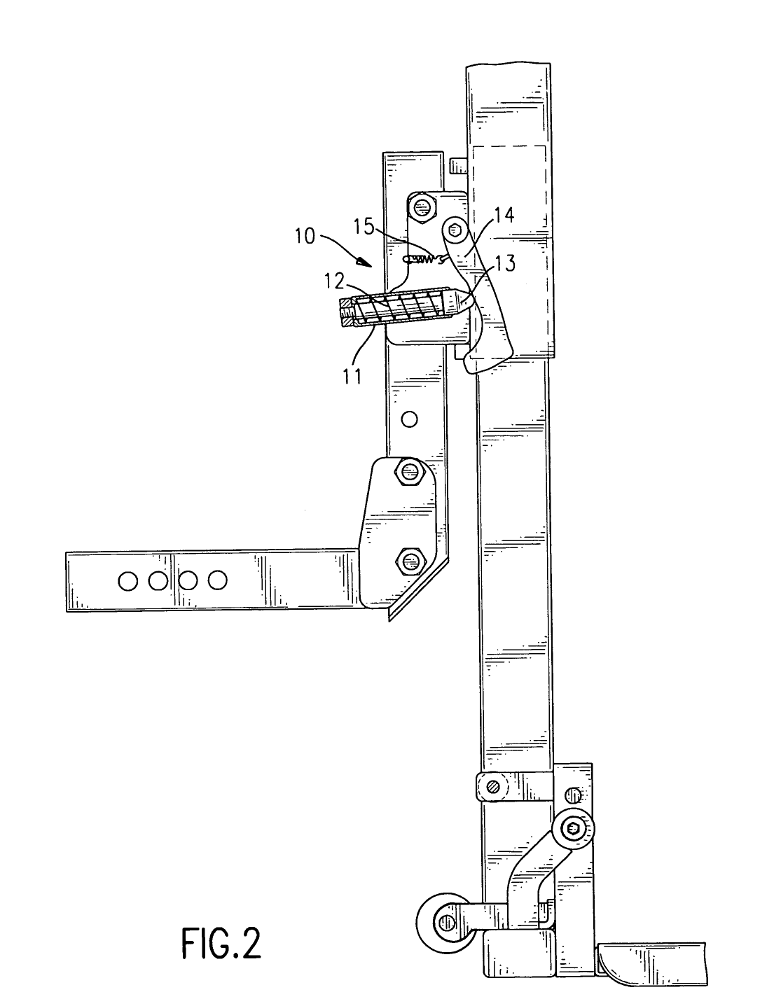

With reference to FIGS. 1 and 2, a cargo lift for a vehicle in accordance with the present invention has a motor (not shown) with a first piston (not shown), an upper stanchion (not numbered), a lower stanchion (not numbered), a mounting bracket (not numbered), a wing (not numbered), two platform brackets (not numbered), a roller bracket (not numbered), a platform (not numbered), and a platform storage device (not numbered).

The way to assemble the motor with the first piston, the upper stanchion, the lower stanchion, the wing, the platform brackets, the roller bracket, the platform and the mounting bracket is the same as the previously described conventional cargo lift (40) and will not be described again except to note specific changes to the configuration of the cargo lift in accordance with the present invention.

The wing has an outside surface (not numbered), a rear edge (not numbered), a front edge (not numbered) and a mounting stub (not numbered). The mounting stub is mounted on and protrudes from the outside surface near the front edge of the wing.

The platform storage device is mounted on the outside of the wing and has an actuating arm (14) and a spring-loaded holder (10). The spring-loaded holder (10) has a cylinder (11), a compressed spring (12), a second piston (13) and a piston nut (not numbered). The cylinder (11) is hollow and has an open end (not numbered) and a partially closed end (not numbered). The second piston (13) has a proximal end (not numbered), a distal end (not numbered), a head (not numbered) and a shaft (not numbered) and is slidably mounted inside the cylinder (11). The head protrudes from the open end of the cylinder (11), and the shaft protrudes from the partially closed end of the cylinder (11). The compressed spring (12) is mounted around the shaft between the head and the partially closed end of the cylinder (11), and the piston nut is screwed onto the shaft outside the cylinder (11) to hold the second piston (13) in the cylinder (11). The cylinder (11) is transversely mounted respectively on the outside surface of the wing attached to the upper stanchion.

The actuating arm (14) has a proximal end (not numbered), a distal end (not numbered), a front edge (not numbered), a rear edge (not numbered) and an enlarged foot (not numbered). The proximal end of the actuating arm (14) is pivotally attached to the mounting stub on the wing. The enlarged foot is formed on the distal end of the actuating arm (14).

The platform storage device further comprises a retaining spring (15) and the actuating arm (14) further comprises a spring tab (not numbered) formed on the rear edge of the actuating arm (14). An L-shaped rod (16) is mounted on and protrudes from the outside surface near the rear edge of the wing. The return spring (15) is mounted between the spring tab on the rear edge of the actuating arm (14) and the L-shaped rod (16). The return spring (15) securely holds the actuating arm (14) against the head of the second piston (13) in the spring-loaded holder (10).

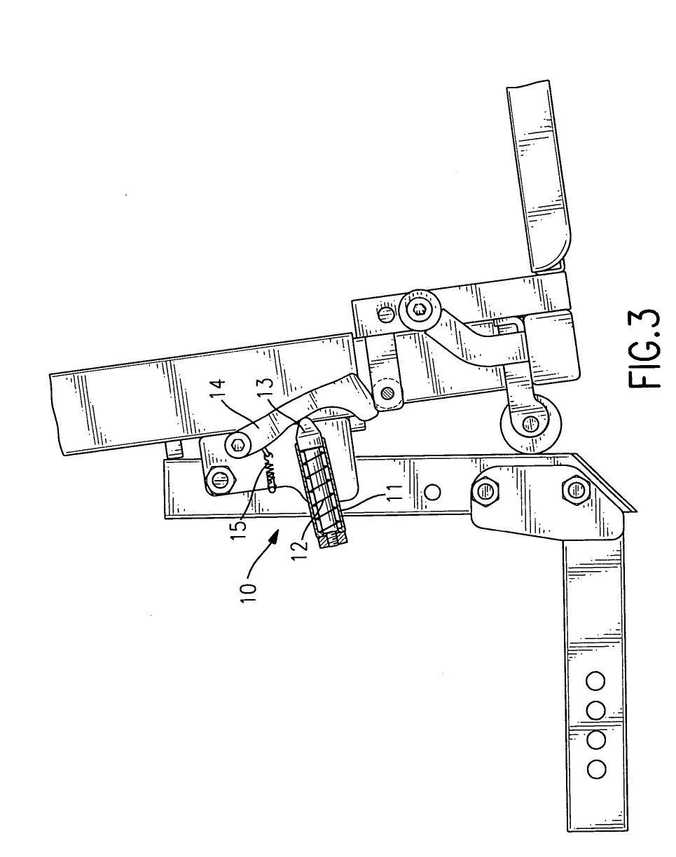

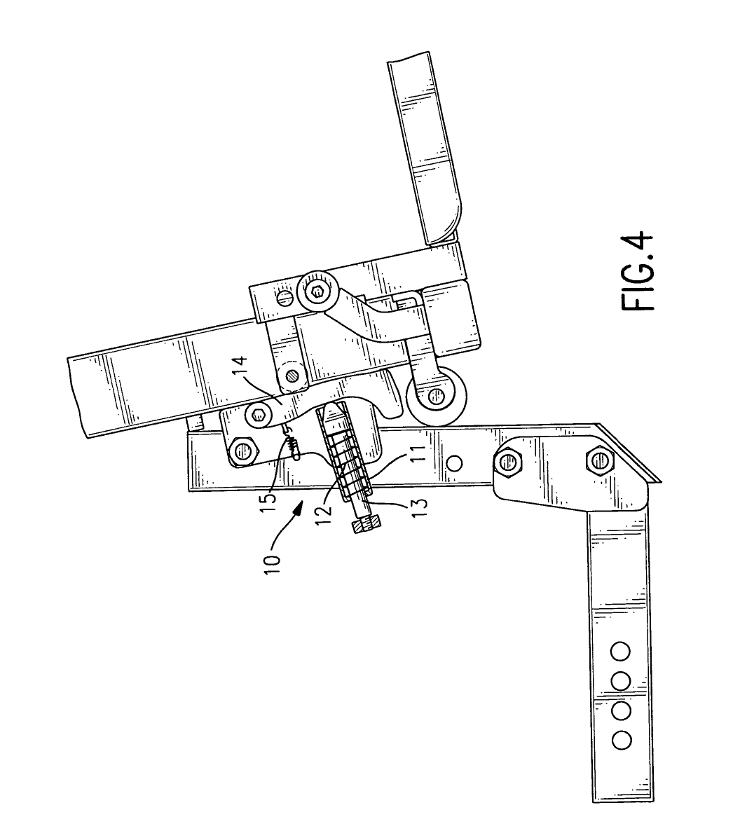

With reference to FIGS. 2 to 4, the motor retracts the lower stanchion into the upper stanchion, and the large roller abuts and rolls on the inclined corner and longitudinal arm of the mounting bracket until the small roller abuts the enlarged feet on the actuating arm (14).

When cargo with added weight is on the platform, the weight of the cargo and the platform overcome the compressed spring (12) and cause the actuating arm (14) to pivot and press the second piston (13) into the cylinder (11). The small roller rolls on the front edge of the actuating arm (14) until the large roller abuts the enlarged feet on the actuating arm (14) and stops the lower stanchion from being retracted any further into the upper stanchion.

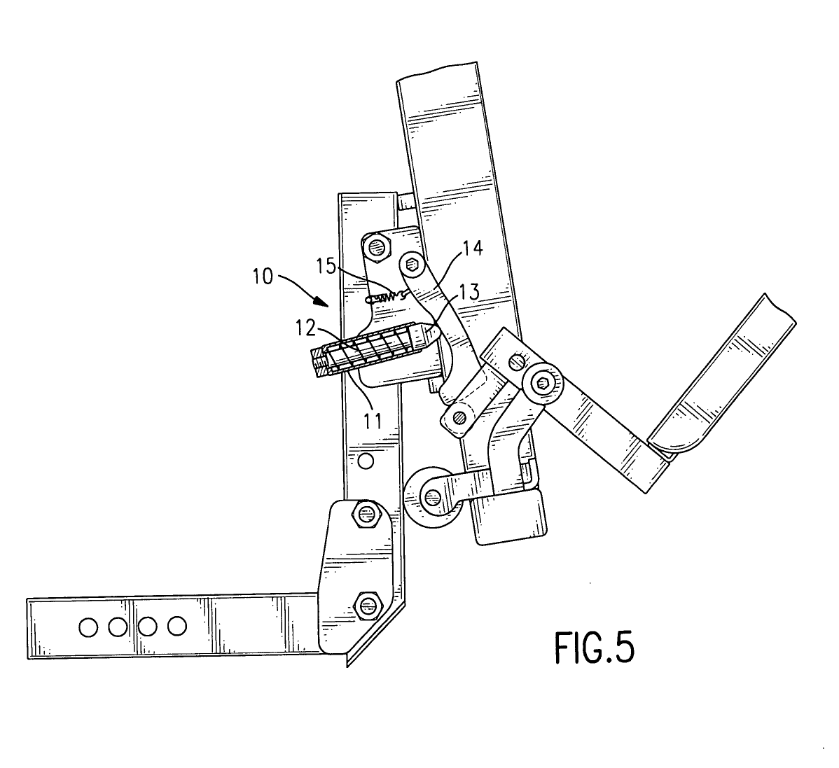

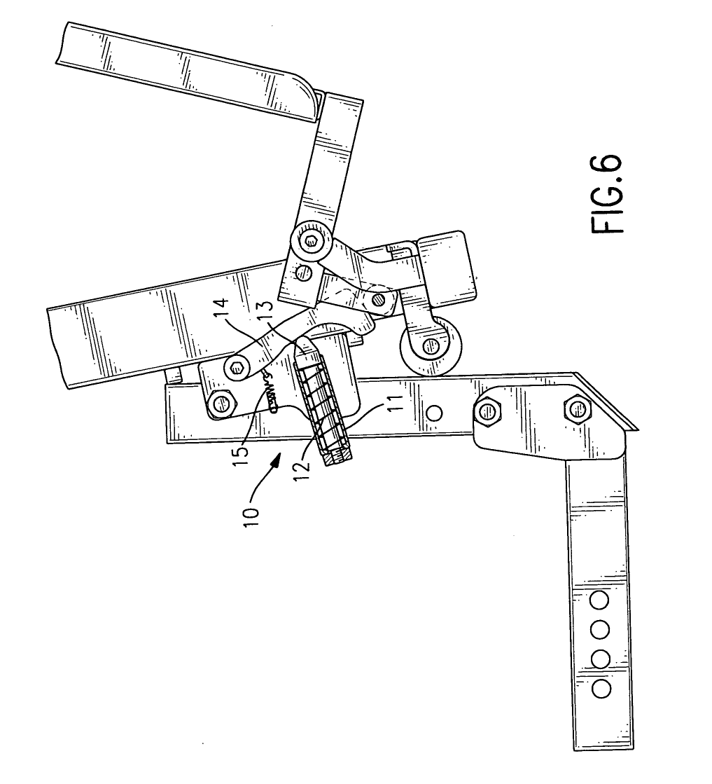

With reference to FIGS. 5 and 6, the weight of the platform by itself cannot overcome compressed spring (12) so the enlarged foot on the actuating arm (14) presses the small roller down as the lower stanchion is retracted into the upper stanchion and raises the platform to a stowed position.

The cargo lift for a vehicle in accordance with present invention has the following advantages:

1. The compressed spring (12) is mounted inside the cylinder (11). When the cargo lift is assembled, the compressed spring (12) cannot be released, thereby preventing anyone from being injured by the compressed spring (12).

2. Because the compressed spring (12) is mounted inside the cylinder (11), the cargo lift has a much more attractive external appearance.

Even though numerous characteristics and advantages of the present invention have been set forth in the foregoing description, together with details of the structure and function of the invention, that the disclosure is illustrative only, and changes may be made in detail, especially in matters of shape, size, and arrangement of parts within the principles of the invention to the full extent indicated by the broad general meaning of the terms in which the appended claims are expressed is to be understood.

1. A cargo lift for a vehicle comprising
an upper stanchion;
a wing attached to the upper stanchion,
a motor having a first piston and mounted on the upper stanchion,
a lower stanchion mounted inside the upper stanchion, connected to the first piston and having
a distal end;
a transverse portion securely mounted on the distal end of the lower stanchion;
two pivot arms attached to the transverse portion of the lower stanchion; and
a large roller mounted on the distal end of the lower stanchion;
a platform mounted on the distal end of the lower stanchion;
two platform brackets pivotally mounted on the platform and each platform bracket having an outer sidewall, the pivot arms of the lower stanchion attached to the outer sidewall of the platform bracket;
a roller bracket mounted on the platform and having
an upper transverse arm with a rear end; and
a small roller rotatably attached to the rear end of the upper transverse arm;
a mounting bracket adapted to mounted on a vehicle and having
a transverse arm adapted to mounted on a vehicle; and
a longitudinal arm pivotally mounted on the wing;
a spring-loaded holder mounted on one of the wing and having
a cylinder with an inner concavity mounted on the wing;
a compressed spring inserted inside the inner concavity of the cylinder; and
a second piston extending through the cylinder and having
a rear end inserted through the compressed spring and fixed by a nut; and
a front enlarged end; and
an actuating arm pivoted with the wing and having
a proximal end pivoting with the wing;
a rear side abutted with the front end of the second piston.

2. The cargo lift for a vehicle as claimed in claim 1, the spring-loaded holder further comprises a return spring which has a front end and a rear end, and an L-shaped rod mounted on the wing near the cylinder, wherein the front end of the return spring is attached to the actuating arm and the rear end of the return spring is attached to the L-shaped rod.
